(19) United States
(12) Patent Application Publication
(10) Pub. No.: US 2025/0103998 A1
(43) Pub. Date: Mar. 27, 2025

(54) LOGISTICS SYSTEM FOR OPTIMISING DELIVERY TIMES

(71) Applicant: WeParsa GmbH, Wiesbaden (DE)

(72) Inventor: Mohammad POURKIANI, Wiesbaden (DE)

(73) Assignee: WeParsa GmbH, Wiesbaden (DE)

(21) Appl. No.: 18/909,042

(22) Filed: Oct. 8, 2024

Related U.S. Application Data
(63) Continuation of application No. 17/604,404, filed on May 12, 2022, now abandoned.

(30) Foreign Application Priority Data
Apr. 17, 2019 (DE) 10 2019 110 220.0

(51) Int. Cl. G06Q 10/08; G06Q 10/1093

(52) U.S. Cl. CPC G06Q 10/08; G06Q 10/1097

(57) ABSTRACT

A logistics system optimizes delivery times of shipments to a plurality of recipients or pick-up and/or return times of shipments from a plurality of recipients. The system includes a main server and at least one service provider client. The main server has a calendar database in which calendar entries representing an availability and/or unavailability of the recipients at their recipient address for at least one period of time are stored. The service provider client communicates with the main server and triggers a query of the calendar entries in the calendar database for a predefined recipient of the plurality of recipients. The main server comprises a query controller for querying the calendar database. The query controller handles query requests from the service provider client for a predefined recipient. When a query request is made by the service provider client for a particular time or a particular period of time, the query controller informs the service provider client, in response, whether the predefined recipient is available or unavailable at the recipient address at the particular time or period of time, based on the calendar entries.

### TECHNICAL FIELD

The present disclosure relates to a logistics system for optimizing delivery times of shipments to a plurality of recipients or pick-up and/or return times of shipments from a plurality of recipients with different or identical recipient addresses.

### BACKGROUND

The mail order business has been growing steadily for years. Meanwhile, it is possible to buy or sell goods worldwide via the Internet practically around the clock, with the consequence that the goods have to be shipped worldwide.

For this purpose, for example, freight forwarders or parcel services are commissioned, which often operate distribution centers—also known as delivery bases—from which delivery to the recipient address is carried out by their own or commissioned delivery agent. Occasionally, the seller delivers the goods itself.

As easy as the purchase process on the Internet is now, the delivery process up to final delivery and, if necessary, the handling of return shipments is often unsatisfactory if the goods purchased do not meet the expected requirements or do not have a guaranteed property.

The ability to order goods on the Internet is a great advantage, in particular for those people who do not have the opportunity to shop in brick-and-mortar stores during normal business hours. However, it is precisely these people who are usually only rarely to be found at their recipient address, and often only at times that are far outside normal business hours. Therefore, delivery is particularly difficult for these people, as they are usually not at home when the ordered goods are to be delivered.

Therefore, the delivery agent must unload the parcel from the delivery vehicle, ring the bell at the recipient address and, if the recipient is not present, leave an appropriate notification in the mailbox and load the parcel back into the delivery vehicle. It is then usually delivered to a pick-up station, such as a post office branch or a packing station, and the customer can usually only pick up his or her shipment there the next day during normal business hours.

Such a failed delivery is disadvantageous for all parties involved. The delivery agent has additional work, as he or she must first drive the shipment to the recipient address and then back to the distribution center or directly to the pick-up station. The parcel service must then either attempt an additional delivery the next day, hold the shipment for pick-up or take the shipment to a pick-up station. In any case, the recipient must wait longer for delivery. If the shipment is taken to a pick-up station, the recipient must then collect the shipment there, which may only be possible during restricted opening hours and may involve long waiting times.

It becomes even more difficult if the goods are to be returned for any reason. As a rule, the recipient must bring the shipments to a post office himself or herself, for example, which ties the recipient to the opening hours of the post office. In addition, poor parking options and longer waiting times are often to be expected there. As such, the return time, that is, the time the recipient has to spend to bring the parcel to a place where it can be picked up by the parcel service without any further action on the part of the recipient, is often very long. In addition, costs for gasoline and parking, for example, are often associated with the return.

Occasionally, parcel services already offer to pick up returns on site, but this often likewise fails due to the frequently poor availability of the recipient at the receiving address.

The costs of parcel services associated with “unavailability of the recipient” are significant for both delivery and pick-up. Efficiency, logistics costs and customer satisfaction in the last mile depend, among other things, on the first delivery rate.

The desired advantages of Internet commerce, namely speed, flexibility and convenience in particular, are then quickly not at all experienced, due to the negative delivery experience. Recipients who have had repeated negative delivery experiences tend to reduce the number of deliveries, that is, they reduce the number of Internet orders or buy only from sellers where delivery is at least perceived to work better.

Since, on average, more than half of the recipients are not reached at their address, in particular in the case of B2C and C2C delivery, it has become common for parcel delivery agents to try to drop off the shipment at a neighbor's house. And even if this leads to a simplification of the delivery process in individual cases, in the worst case it can mean that the shipment is left with a neighbor who is in turn difficult to reach, such that the recipient has to wait a long time before he or she can pick up his or her expected shipment from the neighbor. This also usually does not contribute to an improved shopping experience.

### SUMMARY

As such, it is the object of the present disclosure to specify a logistics system that reduces delivery time, i.e. the time from the moment the shipment is handed over to the parcel service to the moment the shipment is handed over to the recipient, or the return time, i.e. the time the recipient must wait until the shipment can be accepted by the parcel service without further action, or the collection time, i.e. the time until the parcel service picks up the shipment.

This object is achieved by a logistics system for optimizing delivery times of shipments to a plurality of recipients or pick-up and/or return times of shipments from a plurality of recipients with different or identical recipient addresses, the system having a main server and at least one service provider client, wherein the main server has a calendar database in which calendar entries representing an availability and/or unavailability of the recipients at their recipient address for at least one period of time are stored for a plurality of recipients, wherein the main server and/or the service provider client are adapted such that the service provider client communicates with the main server and triggers a query in the calendar database.

Calendar entries are therefore stored in the calendar database for the individual recipients, which indicate whether or not the recipient in question is available at his or her recipient address at particular times or particular time intervals.

As soon as the parcel service or the delivery agent, as the case may be, wants to deliver the shipment, it can use the service provider client to query the calendar database to determine whether or not the recipient is available at the recipient address at the scheduled delivery interval.

If it is determined that the recipient is not present, the corresponding shipment does not have to be loaded into the delivery vehicle. Instead, either the recipient can be informed by a notification card that the shipment can be picked up at a more closely designated parcel shop, or the parcel service can schedule the delivery in another delivery round and query the corresponding availability and/or unavailability at the recipient address for this.

The system prevents parcel shipments from being moved back and forth unnecessarily in the delivery vehicle. The shipment will be loaded into the delivery vehicle only if it can be seen from the calendar database that the recipient is available. Otherwise, the delivery will be delayed or the corresponding parcel will be delivered directly to the pick-up station that holds it ready for pick-up. Even if no delivery is made, the shipment will arrive earlier at the corresponding pick-up station, where the recipient can then collect the shipment. Even then, the delivery time is thus shortened.

In the simplest case, communication is done by the service provider client connecting to the main server and sending an appropriate query to the main server. If a connection of the service provider client with the main server is not possible or not desired, the communication can also be effected by the service provider client sending a message to the main server, for example by means of an e-mail or by a smartphone app, in which the time interval in which the delivery is scheduled is specified. The main server can then read the message, for the example with the aid of a parser. If the message contains a scheduled delivery interval with which the calendar entries for the recipient indicate that the recipient is not available at his or her recipient address, the main server can connect to the service provider client and notify them of the unavailability of the recipient at the recipient address.

In an additional preferred embodiment, it is provided that, if the message contains a scheduled time interval and the database query indicates that the recipient is not available at his or her recipient address during, for example, at least 75% of such time interval, the main server can communicate with the service provider client, for example via appropriate links in the e-mail from the parcel service, and by selecting the options provided by the parcel service, such as postponing the delivery date by up to seven days, can express the unavailability of the recipient to the parcel service. The minimum availability, which in this example amounts to 75%, can be adapted individually. It can also be set to 100%, for example. If the minimum availability is set to 100%, the parcel service will receive the notification that the recipient is not available, even if he or she is only not available for a very short time during the notified time interval.

Furthermore, in an additional preferred embodiment, it can be provided that the database contains experience values for delivery times for certain recipient addresses and then, if the message does not contain a time interval or a scheduled time interval that is longer than a predefined maximum time interval of, for example, 3 hours, calculates a probable delivery interval that is smaller than or equal to the maximum time interval on the basis of the experience values. On the basis of the delivery interval, the parcel service can then be informed of the unavailability of the recipient, if necessary, depending on the minimum availability described above.

In a preferred embodiment, the main server for querying the calendar database has a query controller that handles query requests from the service provider client, wherein, when a query request is received from the service provider client for a particular time or time interval, the query controller notifies the service provider client as a response on the basis of the calendar entries whether the recipient is available or unavailable at the recipient address at the particular time or time interval.

In other words, in the preferred embodiment, the service provider client cannot look into the complete calendar of the recipient. The query controller simply enables a query to be made for a particular time or time interval. Therefore, the service provider client can be prevented from viewing information about other times or time intervals. For data protection reasons, it may be useful to limit the number of queries originating from the service provider client. In particular, once a queried time or time interval, as the case may be, has been marked as available, it is possible to prevent further queries, since once the logistics service provider has determined a time or time interval at which the recipient is present at the recipient address, there is no longer any need for the logistics service provider to query further times or time intervals.

In a preferred embodiment, the time intervals that can be queried can be limited to time intervals that are less than 1 day.

In an additional preferred embodiment, it is provided that, if the recipient is only available during a partial time interval during the queried time interval, the query controller, when queried for a particular time interval by the service provider client, notifies the service provider client as a response, on the basis of the calendar entries, of the partial time interval during which the recipient is available at the recipient address. Alternatively, the query controller could also communicate during which partial time interval the recipient is not available, from which the partial time interval on which the recipient is available is then directly derived.

For example, if a parcel service queries the time interval “Tuesday 8:00 a.m. to 12:00 noon” with the service provider client and the calendar entries indicate that the recipient is only available between 8:00 a.m. and 10:00 a.m. during the queried time interval, the query controller informs the service provider client that the recipient is only available during the part-time interval of “Tuesday 8:00 a.m. to 10:00 a.m.”

Further, the main server can have an order management system that contains information about orders that have been placed but not yet delivered, such that the query controller uses such information to prevent a query for recipients that do not have undelivered shipments. This ensures that a query of the calendar entries can only be made when the recipient is actually expecting a shipment.

In an additional preferred embodiment, it is provided that the main server has a substitute database in which recipient addresses of substitutes are stored for a plurality of recipients.

In this way, the recipient can not only transmit his or her availability data to the main server, but at the same time also store substitutes, including their recipient addresses, to whom the shipment can be delivered if the recipient is not available at the scheduled delivery time. Selected neighbors may be designated as substitutes. It is also possible to designate substitutes who are not immediately adjacent, or even substitutes in other districts or other cities. It is also possible to store the address of one's workplace. As a rule, each recipient will only enter substitute addresses where it is ensured that he or she will be able to pick up the corresponding shipment within a short time after delivery of a shipment.

When planning the delivery route, the parcel service can then query the main server as to whether or not the recipient is available at his or her recipient address at the scheduled delivery time. If the recipient is not available, the logistics service provider receives a substitute address and can deliver the shipment to the substitute address. An unnecessary delivery attempt to the recipient address can be avoided. In addition, the delivery agent does not have to bother neighbors at random in order to possibly deliver the shipment there, but can deliver the shipment to the predefined substitute address in a targeted manner. If the query is already made prior to the commencement of the delivery route, a substitute address that is not called at with the scheduled route can also be accepted. The corresponding shipment is then, if it is determined that the specific recipient is not available at its recipient address, immediately assigned to another delivery route that travels to the recipient address of the substitute.

In an additional preferred embodiment, it is provided that the main server permits the transmission of substitute data to the service provider client only if the recipient has transmitted to the main server or to an operator of the main server an authorization to receive for the designated substitute in the substitute data.

In an additional preferred embodiment, when a query request is received from the service provider client for a particular time or time interval, the query controller, as a response on the basis of the calendar entries, either notifies the service provider client that the recipient is available at the recipient address at the particular time or time interval, or notifies the recipient address of a substitute.

In an additional preferred embodiment, it is provided that calendar entries are stored in the calendar database for at least one substitute, which calendar entries represent an availability and/or unavailability of the at least one substitute at its recipient address for at least one time interval.

By having calendar entries even for the substitute, an unnecessary attempt at delivery to the substitute address can be avoided. In addition, this makes it easier for the logistics service provider to plan the delivery route.

In an additional preferred embodiment, recipient addresses of multiple substitutes are stored for at least one recipient, wherein the recipient addresses are stored in a priority list. Therefore, if the recipient is not available at their recipient address at a particular queried time and the calendar database and the substitute database indicate that multiple substitutes are available at their recipient address during the queried time, the main server communicates the address data of the substitute highest in the priority list to the service provider client. The priority list can depend on other criteria, such as shipment weight. For example, it is usually not desirable to send bulky or extremely heavy shipments to substitutes far away from the recipient address, while this is usually not a problem for very light shipments. Therefore, a plurality priority lists can be provided, which priority lists are selected according to certain criteria.

A particular pick-up station can also be entered as a substitute in the substitute database. For example, if the recipient frequently passes by a first pick-up location that is farther away from his or her recipient address than a second pick-up location, it may be advantageous for the recipient to enter the first pick-up location as a substitute in the substitute database. Other criteria for selecting a different pick-up location may include extended opening hours, improved parking or shorter wait times.

Fellow residents, such as family members, who can be found at the same recipient address, can also be entered as substitutes in the substitute database. Then, delivery to the recipient address can be made even if the recipient is not present, but a fellow resident entered as a substitute is available.

In an additional preferred embodiment, it is provided that the query controller notifies the service provider client of a query request for a particular time or a particular time interval as a response on the basis of the calendar entries, i) that the recipient is at the particular time or the particular time interval at the recipient address is available, ii) that a substitute is available at the recipient address or iii) that neither the recipient nor one of the substitutes is available at the particular time or the particular time interval.

Here as well, a preferred embodiment provides that the query controller, in the event that the substitute is only available during a part-time interval within the queried time interval, reports the part-time interval in which the availability is present.

In an additional preferred embodiment, the substitute database also has alternative recipient addresses for at least one recipient, wherein calendar entries are also provided in the calendar database for the alternative recipient addresses, which calendar entries represent for at least one time interval an availability and/or unavailability of the recipient at the alternative recipient address.

In other words, the recipient himself or herself can be entered in the substitute database as a substitute with an alternative recipient address.

For example, the recipient could enter in the calendar database that he or she can be found at an alternate recipient address on Fridays between 10:00 a.m. and 2:00 p.m.

If the service provider client now queries the time interval “Friday between 10:00 a.m. and 2:00 p.m.,” it is informed of the alternative recipient address as a response and the parcel service can deliver the shipment to the alternative recipient address during the queried time interval.

In an additional preferred embodiment, it is provided that the query controller, in the event that more than one substitute is available at the particular time or the particular time interval, notifies that substitute and his or her recipient address, with which the time interval following the particular time or the particular time interval at which both the substitute and the recipient are available is closest to the particular time or the particular time interval. If a plurality of substitutes is available closest to the particular time or particular time interval, depending on the embodiment implemented, the main server can either communicate the address of the substitute closest to the recipient address of the recipient to the service provider client, or if a priority list exists, communicate the address of the substitute ranked highest in the priority list.

This further reduces the delivery time, i.e. the time it takes for the shipment to be handed over to the recipient. For example, if the recipient has specified two available substitutes, and the first substitute is unavailable for an extended period of time immediately after the scheduled delivery, while the other substitute is frequently available after the scheduled delivery, delivery is made to the substitute who is available earlier or whose availability coincides earlier with the availability of the actual recipient. This prevents the shipment from being delivered to a substitute who, after delivery, is available only at times when the shipment recipient is not available.

In a particularly preferred embodiment, the delivery time can be further reduced by considering a second substitute when optimizing the delivery time. The second substitute can act as intermediate storage. The query controller then issues to the service provider client, in the event that more than one substitute is available at the particular time or time interval, that substitute and its recipient address at which the time interval following the particular time or time interval at which both the second substitute and the recipient are available is closest to the particular time or the particular time interval, if it results in a time interval that is after the particular time or the particular time interval and before the time interval at which both second substitute and recipient are available, at which both the substitute and the second substitute are available.

In other words, the shipment is delivered to the substitute although there is no time interval in the near future at with both the substitute and the recipient are available to deliver the shipment. Instead, however, it is made possible for the substitute to hand over the shipment delivered to him or her to the second substitute, whose availability will make it possible to hand it over to the recipient in the near future. In one embodiment, it can be provided that delivery via more than one substitute requires that all intermediary substitutes have designated each other as substitutes.

In an additional preferred embodiment, it is provided that the main server has a recipient interface that is designed such that either a plurality of recipients can make calendar entries or synchronization with an electronic calendar of the recipient can take place. For example, the recipient can either connect to the main server and update his or her calendar entries there directly. Such update can take place daily or even hourly. Alternatively, this can be carried out by the electronic calendar of the recipient through a periodic synchronization with the calendar database of the main server.

In an additional preferred embodiment, other service provider clients are provided, wherein preferably, one service provider client is arranged on each delivery vehicle.

Thus, the corresponding parcel delivery agent can check again, immediately prior to the scheduled delivery, as to whether the recipient is available and, if necessary, refrain from the delivery attempt, i.e. unloading the shipment, manually transporting the shipment to the recipient address and ringing the recipient's doorbell if the availability is no longer present.

In an additional preferred embodiment, the logistics service provider client and the main server are designed to allow an intended delivery time or an intended delivery time interval to be entered into the calendar database. For example, this can take place automatically by the query controller when it has confirmed availability in response to a query from the service provider client. The system assumes that a query is made via the service provider client only if delivery is scheduled in the queried time interval. If the availability of the recipient is then confirmed at his or her recipient address, it can be assumed that the delivery will then also take place as scheduled and that this will be entered in the calendar database.

This has a whole range of advantages. Thus, by accessing his or her calendar database entry, the recipient can now know when the delivery is to take place and adjust his or her further activities accordingly.

This can be a great advantage, in particular for return shipments.

In a preferred embodiment, it is therefore provided that the main server has a recipient interface, via which a recipient can request scheduled delivery intervals or times from the calendar database with the substitutes entered for the recipient.

For example, the recipient can use the main server to query when the next delivery date will be at one of the substitutes designated by him and deposit the return shipment there, such that the delivery agent can take the return shipment of the recipient deposited there when delivering a shipment to the substitute. Therefore, the recipient does not have to bring his or her return shipment to the post office or ensure his or her presence at a pick-up time targeted by the parcel service, but can simply drop off the return shipment at the substitute designated by him or her, who, according to the calendar database, is expecting the delivery of a shipment shortly, such that the delivery agent can take the return shipment of the recipient to his or her substitute. In the event that the query result is not satisfactory, because, for example, none of the substitutes has noted a delivery date, in a preferred embodiment, it can be provided that the query is maintained for a predefined time and that the recipient receives a message if the response to the query changes. Thus, the recipient might initially receive the response that no substitute is expecting delivery. If a substitute enters a delivery in his or her calendar shortly thereafter, the recipient could receive a follow-up response that a pick-up from such substitute is now possible after all.

In an additional preferred embodiment, the main server has an information database in which delivery information is stored for a plurality of recipients, wherein the service provider client is designed to query the delivery information for the predefined recipient. Delivery information may include, for example, the telephone number of the recipient, the indication of a preferred drop-off location and/or driving instructions, such as “8th floor, left hallway, second door on the right.”

Further advantages, features and possible applications will become clear from the following description of a preferred embodiment and the accompanying figures.

### BRIEF DESCRIPTION OF THE DRAWINGS

FIG. 1 is a schematic illustration of a logistics system.

FIG. 2 is a schematic illustration of calendar entries.

### DETAILED DESCRIPTION

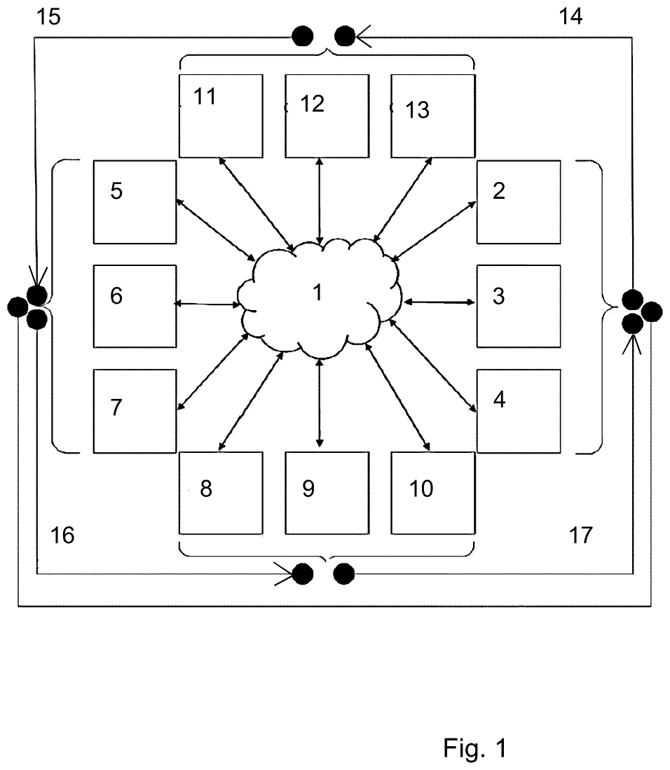

FIG. 1 shows a schematic illustration of the logistics system in accordance with the disclosure. The system has a main server 1 that can be connected to a series of recipients 2, 3, 4. Furthermore, a series of parcel services 5, 6, 7, a series of delivery agents 8, 9, 10, and a series of shippers, such as online stores, 11, 12, 13 may connect to the main server 1. The parcel recipients 2, 3, 4 can make a purchase from the online stores 11, 12, 13 as shown by means of the arrow 14. The order can either be placed directly with the mail order vendors or processed through the main server 1. As soon as the online stores have received the corresponding order, they will package the goods and transmit a corresponding transport order 15 to the parcel service 5, 6, 7. The responsible parcel service can schedule the individual delivery routes by connecting to the main server 1 with the aid of a service provider client and carrying out a calendar database query there. The parcel recipients 2, 3, 4 have already entered their availabilities in the corresponding calendar that is stored in the calendar database of the main server 1. The described connection can also be passive, i.e. without an active connection by the service provider client. For example, the service provider client can send an e-mail to the main server, which reads or parses, as the case may be, the e-mail and then initiates a calendar data request.

Even if the parcel service is not willing to use a service provider client, the logistics system in accordance with the disclosure can be used. For example, in one embodiment, the mail order vendors may initiate a database query via a service provider client and use the corresponding response from the main server when commissioning the parcel service.

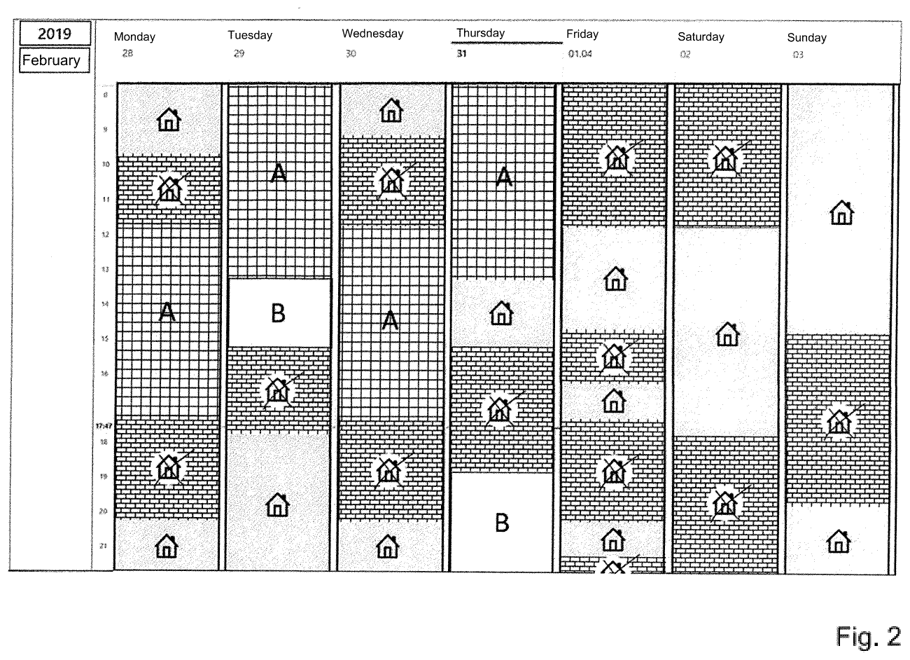

A corresponding calendar of a recipient is shown schematically in FIG. 2. One can see there that, for each day and time, there is an availability, represented by a house symbol, an unavailability, represented by a crossed-out house symbol, along with an availability at another address, such as a workplace address A or a friend B. If the recipient is not available either at his or her recipient address or at his or her alternative recipient address, specifically the address of his or her workplace or his or her friend, to which substitute the delivery can be made instead is noted in a substitute database. In doing so, there can also be a corresponding calendar for each substitute.

The parcel service can now request a particular delivery interval in which it plans to deliver the goods. As a response to the query of the time interval for the queried time interval, the query controller of the main server 1 outputs the information as to whether the recipient is at home, whether he or she is at his or her workplace, whether he or she is not available or whether a substitute with a substitute address is available.

With such information, the parcel service 5, 6, 7 can optimize the route scheduling. If the shipment is assigned to a different route, it may be necessary to query a different delivery interval again.

As soon as an availability has been communicated to the service provider client, the delivery date is fixed and entered into the calendar database by the main server 1, such that the recipient is informed or can inform himself or herself about the scheduled delivery. For example, the main server can send a message to the recipient, for example via a messenger, in order to inform him or her of the scheduled delivery.

The delivery order 16 is then transmitted by the parcel service 5, 6, 7 to a delivery agent 8, 9, 10, which loads all the shipments scheduled for the scheduled route into the delivery vehicle and departs on the scheduled route. Shortly before manually delivering the shipment, i.e., unloading the shipment from the delivery vehicle, the delivery agent 8, 9, 10 can use the service provider client, which can also be provided on the delivery vehicle, to query the calendar of the recipient or the intended substitute again in order to ensure that availability is still guaranteed. If the calendar entry has been updated in the meantime or the scheduled delivery has been delayed, the current availability information can be queried again, such that the time-consuming unloading and reloading of the shipment after an unnecessary delivery attempt can be dispensed with if necessary. The main server could automatically transmit a corresponding message to the logistics service provider client in cases where an update of the calendar data reveals that a recipient is no longer available at a scheduled delivery time.

When the delivery agent performs a query, it is usually not a time interval, but a time, that is queried. If the recipient is available according to the calendar entry, this is communicated to the delivery agent. In addition, the recipient can be informed that delivery is imminent. If necessary, additional delivery information, such as the telephone number of the recipient, a selected drop-off location (for example, the patio) or driving instructions to the front door of the recipient, can be transmitted to the delivery agent in order to expedite delivery. If, contrary to expectations, the recipient is not present according to the updated calendar entry, the shipment can be delivered to a substitute, if a substitute has been appointed in the immediate vicinity. Otherwise, the delivery process can be aborted and the recipient can be notified digitally that the delivery attempt was unfortunately not successful. As such, the delivery agent does not even have to drop the usual notification card in the mailbox of the recipient; rather, the delivery agent informs the recipient electronically via the main server that the delivery process was not successful.

The advantages of this aspect of the logistics system become particularly clear in the example of a parcel service that is to deliver a plurality of parcels, for example four parcels, in one and the same high-rise building. Here, the procedure could be as follows: First, the delivery agent drives to the corresponding high-rise building. He or she then uses a smartphone app to scan the four parcels to be delivered in such high-rise building.

Assume that the recipient of the first parcel is present according to the calendar database entry and is currently online. The scanning process results in a calendar database query and the recipient of the first parcel is informed, for example via a messenger, by the main server that the parcel delivery is imminent.

Assuming that the recipient of the second parcel is not present, and that his or her designated substitute is a neighbor and is present. In this case, the delivery agent receives a notification that the parcel must be left with the neighbor and the neighbor receives information, for example via a messenger, that a parcel delivery is imminent.

Assuming that the recipient of the third parcel is absent and that no substitute is designated or available. In this case, a notification, which can be sent by e-mail for example, can be generated automatically during scanning, in which the recipient is informed that the delivery attempt has failed and where and when the parcel can be picked up. Such notification can be sent automatically. Alternatively, the notification could be sent only after a certain time interval, such as after 30 minutes, such that the delivery agent has the opportunity to attempt delivery of the third parcel on site with the recipients he or she visits in any event in order to drop off one of the parcels. If such a delivery is not possible to a neighbor not designated as a substitute, the delivery agent can come a second time, wherein the message for this can likewise be generated and sent automatically. If this is not possible, the original message will then be sent.

Assuming that the recipient of the fourth parcel is present according to the calendar database entry but is currently offline. In this case, the service provider client could establish a voice connection via the main server, for example via the telephone line, to the recipient of the fourth parcel, in order to inform him or her that the parcel delivery is imminent.

On the basis of the additional information available about the individual recipients of the first, second and fourth parcels, the main server can send an optimized route within the high-rise building to the delivery agent. For example, the route could first direct the delivery agent to the ninth floor in order to deliver the second parcel there. Possibly existing additional information, such as “after exit left, apartment no. 906” can be provided as an addition. After that, the delivery agent could be directed to the fourth floor to deliver the fourth parcel. At the end, the delivery agent could then be used to deliver the first parcel to the third floor. If the delivery agent decides to take the third parcel, he or she could ask the recipients of the second, fourth and first parcels one after the other to accept the shipment.

In this case, the recipients are always contacted via the main server, such that it is not necessary to provide the relevant contact information, such as telephone number or e-mail address, to the delivery agent.

The recipient and his or her designated substitutes together form a group, which can also be used to pick up returns. If a shipment is to be returned, the recipient can connect to the main server and note the return shipment request. The main server then outputs, for example, the information for which substitute a delivery is scheduled, such that the recipient can deposit the return shipment there. If multiple substitutes are scheduled for delivery, the main server can name the substitute that is located closest to the recipient address.

### LIST OF REFERENCE SIGNS

1 Main server
2,3,4 Recipient
5,6,7 Parcel service
8,9,10 Delivery agent
11,12,13 Shippers, such as online stores
14 Purchase
15 Transport order
16 Delivery order
17 Delivery to the recipient

The invention claimed is:

1. A logistics system for optimizing delivery times of shipments to a plurality of recipients or pick-up and/or return times of shipments from a plurality of recipients with different or identical recipient addresses, the system comprising:
a main server; and
at least one service provider client,
wherein the main server comprises a calendar database in which calendar entries representing an availability and/or unavailability of the recipients at their recipient address for at least one period of time are stored for a plurality of recipients,
wherein the service provider client is adapted such that the service provider client communicates with the main server and triggers a query of the calendar entries in the calendar database for a predefined recipient of the plurality of recipients.

2. The logistics system according to claim 1,
wherein the main server comprises a query controller for querying the calendar database that handles query requests from the service provider client for a predefined recipient,
wherein, when a query request is received from the service provider client for a particular time or time interval, the query controller notifies the service provider client as a response based on the calendar entries whether the predefined recipient is available or unavailable at the recipient address at the particular time or time interval.

3. The logistics system according to claim 2,
wherein the main server comprises a substitute database in which recipient addresses of substitutes are stored for the plurality of recipients.

4. The logistics system according to claim 3,
wherein, when a query request is made by the service provider client for a particular time or a particular period of time, the query controller, as a response based on the calendar entries, either notifies the service provider client that the predefined recipient is available at the recipient address at the particular time or time interval or notifies the recipient address of a substitute.

5. The logistics system according to claim 3,
wherein calendar entries are stored in the calendar database for at least one substitute, which calendar entries represent an availability and/or unavailability of the at least one substitute at its recipient address for at least one time interval.

6. The logistics system according to claim 5,
wherein, when a query request is made by the service provider client for a particular time or a particular period of time, the query controller, as a response based on the calendar entries, communicates either
i) that the predefined recipient is available at the recipient address at the particular time or time interval,
ii) that a substitute is available at the recipient address thereof or
iii) that neither the predefined recipient nor any of the representatives is available at the particular time or time interval.

7. The logistics system according to claim 6,
wherein the query controller, in case that more than one substitute is available at the particular time or time interval, notifies that substitute and his or her recipient address, with which the time interval following the particular time or time interval at which both the representative and the predefined recipient are available is closest to the particular time or time interval.

8. The logistics system according to claim 1,
wherein the main server has a recipient interface that is designed such that either a plurality of recipients can make calendar entries or synchronization with electronic calendars of the recipients can take place.

9. The logistics system according to claim 1,
wherein a plurality of service provider clients are provided, and
wherein one service provider client is arranged on each delivery vehicle.

10. The logistics system according to claim 3,
wherein the service provider client and the main server are designed to allow an intended delivery time or an intended delivery time interval to be entered into the calendar database,
wherein, when the service provider client has been notified of the availability of the recipient in response to a query of a time interval or a time, the entry of the queried time interval or the queried time into the calendar database is per-formed automatically by the query controller.

11. The logistics system according to claim 10,
wherein the main server has a recipient interface, via which a recipient can request scheduled delivery intervals or times from the calendar database with the substitutes entered for such recipient.

12. The logistics system according to claim 11,
wherein the main server has an information database in which delivery information is stored for a plurality of recipients.
wherein the service provider client is designed to query the delivery information for the predefined recipient.
